(19) United States
(12) Patent Application Publication
(10) Pub. No.: US 2009/0166160 A1
(43) Pub. Date: Jul. 2, 2009

(54) MULTI-LEVEL MICRO-SWITCH

(75) Inventor: Lei Song, Beijing (CN)

Correspondence Address: YING CHEN;Chen Yoshimura LLP, 255 S. GRAND AVE., # 215, LOS ANGELES, CA, 90012, US

(73) Assignee: BEIJING RUTIAN SCIENCE AND TECHNOLOGY CO., LTD, Beijing (CN)

(21) Appl. No.: 12/110,504

(22) Filed: Apr. 28, 2008

(30) Foreign Application Priority Data
Dec. 27, 2007 (CN) 200710304394.X

(51) Int. Cl. H01H 3/02

(52) U.S. Cl. 200/61.93

(57) ABSTRACT

The present invention relates to a multi-level micro-switch comprising a housing and a fixed supporting cylinder disposed in the center of the housing and extending upwards along the axis of the housing, wherein a plurality of multi-level supporting cylinders are sequentially and flexibly contained in the fixed supporting cylinder. The bottom of the fixed supporting cylinder is connected to the housing and a plurality of beams is constantly arranged around the fixed supporting cylinder. A slide ring is arranged on the inner side of the housing which fits with the vacancy of the housing. An inner casing is contained in and flexibly connected to the housing, touching the slide ring at the bottom end, and a conductive ball is disposed in the vacancy above the beams. The invention may choose different thresholds of detection sensitivity for each application and be typically utilized as a movement-detection unit in an electronic surveillance system, especially an anti-theft system.

### BACKGROUND OF THE INVENTION

1. Field of the Invention

The present invention relates to a multi-level micro-switch typically utilized as a vibration detection unit in an electronic surveillance system, especially an anti-theft system, which belongs to the field of electronics.

2. Description of Related Art

A micro-switch is commonly utilized in various electronic surveillance systems, especially anti-theft systems, as a micro-movement-detection unit. A micro-switch has two connecting terminals that are connected in a movement-detection circuit. The housing of the micro-switch is fixed to a guarded article. When the article is moved to a certain degree, a movable item inside the micro-switch may be caused to move to a position between the two connecting terminals, looping through the movement detection circuit and thus outputting movement-related signals. Chinese patent CN88212825.6 discloses a micro-switch comprising a plastic outer casing, a supporting cylinder holder, a flexible inner, a plastic cover spiral connection and a lead wire. A supporting cylinder seated on the supporting cylinder holder is connected to a casing of a rubber umbrella embedded in a conductive ring. The supporting cylinder, which is exposed out of the casing, may support a conductive ball. The peripheral of the rubber umbrella is fixed in the movable inner sleeve by two clamps and is fitting to a return spring. Both the outer and the inner casings have a lock groove. A lock key is attached to the central pivot in the groove on the outer casing. By means of the return spring and the lock key, the micro-switch may be freely shut on/off, thereby starting/terminating the operation of the surveillance system. Such a micro-switch may be fixed to a safe, a window or other stationary articles to guard against burglary. Once the stationary article is moved, or even touched, there is a motion in the micro-switch and the motion may cause the conductive ball to roll, along any direction, to come between the rubber umbrella and the inner sleeve, looping through the movement detection circuit. The merits of such a micro-switch include low cost, high sensitivity, easy fabrication, fast set-up and not relying on electricity. However, the application for such a micro-switch is limited, because the threshold of sensitivity (or sensitivity), which is designed to allow motions of amplitude below a certain value to be ignored, is invariable. When a micro-switch of too high or too low threshold of sensitivity is used, there may be detection failures or false alarms triggered by natural factors. It is thus desired that the threshold of sensitivity may be adjusted according to the guarded article and its surrounding circumstance.

### SUMMARY OF THE INVENTION

To overcome the above shortcomings, the present invention provides a multi-level micro-switch that may choose the threshold of sensitivity according to the application, thereby reducing detection failures and false alarms.

The solution is a multi-level micro-switch comprising a housing and a fixed supporting cylinder disposed in the center of the housing and extending upwards along the axis of the housing, wherein a plurality of multi-level supporting cylinders are sequentially and flexibly contained in the fixed supporting cylinder.

The multi-level micro-switch further comprises an inner casing and a conductive ball, wherein the bottom of the fixed supporting cylinder is connected to the housing; a plurality of beams is constantly arranged around the fixed supporting cylinder, the plurality of beams being hinged to the top end of the fixed supporting cylinder at the inner end and extending towards the wall of the housing at the outer end, each beam having a conductive layer on the top surface in the center and a link pair below, the link pair, composed of two hinged links, being hinged to the lower portion of the corresponding beam at the outer end and to the side wall of the fixed supporting cylinder at the inner end; and wherein a slide ring is further arranged on the inner side of the housing which fits with the vacancy of the housing, the slide ring being equipped with a spring at the bottom end for pressing against the slide ring and being in touch with the outer end of the beams at the top end, the inner casing being contained in and flexibly connected to the housing and in touch with the slide ring at the bottom end, and the conductive ball being disposed in the vacancy above the beams. The principle of the invention is: when the conductive ball is placed on the supporting cylinders, lower the inner casing to press down the outer end of each beam through the slide ring. Then the beams are kept lower outwardly, forming a pyramidal surface. The heights of the multi-level supporting cylinders in the fixed supporting cylinder are sequentially adjusted in such a way that a multi-level supporting cylinder or fixed supporting cylinder corresponding to a desired threshold of sensitivity is supporting the conductive ball. Fix the micro-switch to a guarded article. Once there is a motion in the article that is greater than or equal to the threshold of sensitivity, the conductive ball will roll from the corresponding supporting cylinder to a position between the beam and the internal surface of the inner casing. As a result, an inner wiring of the micro-switch is connected. There are two methods for the inner wiring. One is to provide even-numbered beams and corresponding conductive layers attached thereon, and then connect the conductive layers alternately to each of the two connecting terminals respectively, through wires. When the conductive ball rolls down to be hold by a pair of proximate beams, the two connecting terminals are connected, that is, the inner wiring is connected. Another method is to provide an annual conductor on the internal surface of the wall of the inner casing, and to connect the two connecting terminals respectively to the conductive layers on the beams and the annual conductor on the inner casing. In this way, the fallen conductive ball may also loop through the inner wiring.

As a plurality of supporting cylinders, including the fixed supporting cylinder, is sequentially contained, the conductive ball may be supported by any one of the pluralities of supporting cylinders. As such, the different diameters of supporting cylinder may allow the threshold of sensitivity to be adjustable for variable applications. The greater the diameter is, the harder the conductive ball gets fallen. The most inner supporting cylinder may be made as a solid.

### BRIEF DESCRIPTION OF THE DRAWINGS

FIG. 1 is a schematic view of the micro-switch.

### DESCRIPTION OF THE EMBODIMENTS

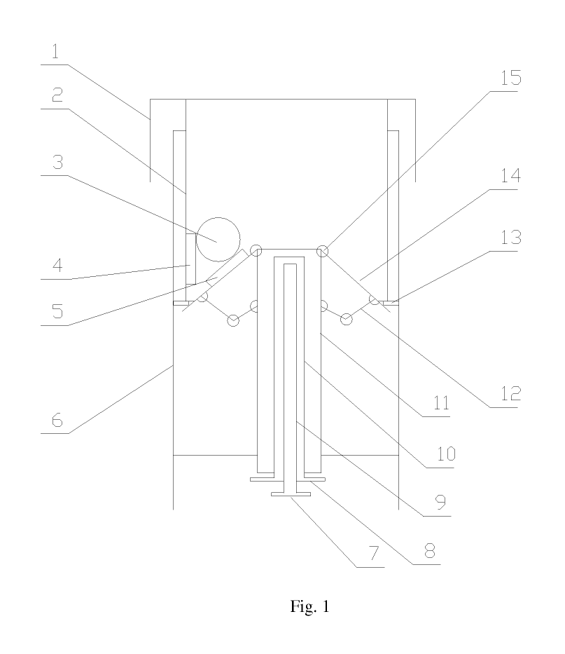

With reference to FIG. 1, the invention provides a micro-switch comprising a housing 6, a fixed supporting cylinder 11, an inner casing 2 and a conductive ball 3. The fixed supporting cylinder is disposed in the housing and extends upwards along the axis of the housing, and its bottom is connected to the housing. A plurality of multi-level supporting cylinders 9, 10 is sequentially and flexibly contained in the fixed supporting cylinder. A plurality of beams 14 is constantly arranged around the fixed supporting cylinder. Each beam is hinged to the top end of the fixed supporting cylinder at the inner end through a hinge 15, and extends towards the wall of the housing at the outer end. The hinges may be arranged in a mounting ring. Each beam has a conductive layer 5 on the top surface in the center and a link pair 12 below. The link pair, composed of two hinged links, is hinged to the lower portion of the corresponding beam at the outer end and to the sidewall of the fixed supporting cylinder at the inner end. A slide ring 13 is further arranged on the inner side of the housing that fits with the vacancy of the housing. The slide ring is equipped with a spring (not shown) at the bottom end for pressing against the slide ring and in touch with the outer end of the beams at the top end. The inner casing is contained in and flexibly connected to the housing and in touch with the slide ring at the bottom end. The conductive ball is disposed in the vacancy above the beams.

The inner casing has an outer wall at the external side of the housing and is attached to the housing by spirals. The attachment spirals on the inner casing may be arranged on the external surface of its main body or on the internal surface of its outer wall, and respectively, the spirals on the housing may be arranged on its internal or external surface. A beam, a corresponding link pair and the fixed supporting cylinder form a quadra-linkage. As such, the slope of the beams may be adjusted by altering the height of the bottom end of the inner casing. And when the beams are kept higher outwardly, the conductive ball will remains upon the supporting cylinders and the micro-switch is off.

The fixed supporting cylinder and the plurality of multi-level supporting cylinders are sequentially contained, each being attached by a spiral at the lower part. The cap 7, 8 are provided at the bottom end of each of the plurality of multi-level supporting cylinders. By rotating a cap with hands until it's stuck by the proximately outer supporting cylinder, the corresponding multi-level supporting cylinder is raised up to support the conductive ball at a position corresponding to a threshold of sensitivity. For the accuracy of the adjustment of a certain multi-level supporting cylinder, it should be reassured that all the more outer multi-level supporting cylinders are at their highest positions and all the more inner multi-level supporting cylinders are not too high to touch the conductive ball.

An annular conductor 4 may be disposed, as required, on the internal surface of the wall of the inner casing for contacting with the conductive ball.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A multi-level micro-switch, comprising:
a housing;
a first fixed supporting cylinder disposed in a center of the housing and extending upwards along an axis of the housing; and
a plurality of multi-level second supporting cylinders sequentially and flexibly contained in the first fixed supporting cylinder.

2. The multi-level micro-switch according to claim 1, further comprising:
an inner casing;
a conductive ball;
wherein a bottom of the first fixed supporting cylinder is connected to the housing;
a plurality of beams constantly arranged around the first fixed supporting cylinder, the plurality of beams being hinged to a top end of the first fixed supporting cylinder at its inner end and extending towards a wall of the housing at its outer end, each beam having a conductive layer on a top surface in a center and a link pair below, wherein the link pair includes two hinged links and is hinged to a lower portion of the corresponding beam at its outer end and to the side wall of the first fixed supporting cylinder at its inner end;
a slide ring arranged on an inner side of the housing which fits with a space of the housing; and
a spring disposed at a bottom end of the slide ring for pressing against the slide ring, the spring being in touch with the outer end of the beams at its top end,
the inner casing being contained in and flexibly connected to the housing and being in touch with the slide ring at a bottom end, and the conductive ball being disposed in a space above the beams.

3. The multi-level micro-switch according to claim 2, wherein the inner casing has an outer wall at an external side of the housing and is attached to the housing by spirals.

4. The multi-level micro-switch according to claim 3, wherein the spirals for attaching the inner casing and the housing are arranged on an external surface of a main body of the inner casing and on the inner side of the housing.

5. The multi-level micro-switch according to claim 3, wherein the spirals for attaching the inner casing and the housing are arranged on an internal surface of the outer wall of the inner casing and on an external side of the housing.

6. The multi-level micro-switch according to claim 3, wherein each of the beams, the corresponding link pair and the fixed supporting cylinder form a quadra-linkage.

7. The multi-level micro-switch according to claim 2, wherein the plurality of second supporting cylinders are sequentially contained, each being attached by a spiral at its lower part.

8. The multi-level micro-switch according to claim 7, further comprising a cap at a bottom end of each of the plurality of multi-level second supporting cylinders.

9. The multi-level micro-switch according to claim 8, wherein the number of the beams is even, and a conductive layer is disposed on the top surface of each beam, the conductive layers on each beam being alternately connected to each of two connecting terminals of the micro-switch through wires.

10. The multi-level micro-switch according to claim 8, wherein a conductive layer is disposed on the top surface of each beam, further comprising an annular conductor disposed on an internal surface of a wall of the inner casing, the conductive layer and the annular conductor being connected to each of two connecting terminals of the micro-switch through wires.

11. The multi-level micro-switch according to claim 3, wherein the plurality of supporting cylinders are sequentially contained, each being attached by a spiral at the lower part.

12. The multi-level micro-switch according to claim 11, further comprising a cap at a bottom end of each of the plurality of multi-level second supporting cylinders.

13. The multi-level micro-switch according to claim 12, wherein the number of the beams is even, and a conductive layer is disposed on the top surface of each beam, the conductive layers on each beam being alternately connected to each of two connecting terminals of the micro-switch through wires.

14. The multi-level micro-switch according to claim 13, wherein a conductive layer is disposed on the top surface of each beam, further comprising an annular conductor disposed on an internal surface of a wall of the inner casing, the conductive layer and the annular conductor being connected to each of two connecting terminals of the micro-switch through wires.

15. The multi-level micro-switch according to claim 4, wherein the plurality of supporting cylinders are sequentially contained, each being attached by a spiral at the lower part.

16. The multi-level micro-switch according to claim 15, further comprising a cap at a bottom end of each of the plurality of multi-level second supporting cylinders.

17. The multi-level micro-switch according to claim 16, wherein the number of the beams is even, and a conductive layer is disposed on the top surface of each beam, the conductive layers on each beam being alternately connected to each of two connecting terminals of the micro-switch through wires.

18. The multi-level micro-switch according to claim 17, wherein a conductive layer is disposed on the top surface of each beam, further comprising an annular conductor disposed on an internal surface of a wall of the inner casing, the conductive layer and the annular conductor being connected to each of two connecting terminals of the micro-switch through wires.
